(19) United States
(12) Patent Application Publication
(10) Pub. No.: US 2022/0074416 A1
(43) Pub. Date: Mar. 10, 2022

(54) Fluid Flow Power Delivery System

(71) Applicant: Robert M Pangonis, Escondido, CA (US)

(72) Inventor: Robert M Pangonis, Escondido, CA (US)

(21) Appl. No.: 16/948,243

(22) Filed: Sep. 9, 2020

(51) Int. Cl. F04D 13/06; F04D 29/22; F03B 7/00

(52) U.S. Cl. CPC F04D 13/068; F04D 29/22; F05B 2260/421; F05B 2220/7062; F03B 7/00

(57) ABSTRACT

A system of recycling power from flowing fluids, uses a fluid pump, e.g., a water pump or an air pump, driven from a power source to create a flow. A fluid movement recycling device, is located in the path of the fluid flow, such that the fluid flowing causes the fluid movement recycling device to rotate. A DC motor, receives the rotation from the fluid movement rotating device, and produces an output of DC power, which charges a battery that itself is used to drive the fluid pump.

### BACKGROUND

Many modern devices consume power in order to create a forced fluid flow.

It is desirable to use regenerate as much of the energy as possible.

### SUMMARY OF THE INVENTION

The inventor recognized a number of drawbacks with the current systems.

Embodiments describe creating DC power for, charging battery packs from flowing fluid systems. Embodiments describe the fluid being water and/or air.

An embodiment describes installing a waterwheel into a water line, using that waterwheel to drive a DC motor which is configured as a generator, to charge battery packs, and where the battery pack can provide some additional power for the flowing water.

### BRIEF DESCRIPTION OF THE DRAWINGS

In the Drawings:

FIG. 1 shows an embodiment using a water wheel to recover energy from a flowing water stream;

FIG. 2 shows an air recovering system which recovers energy from flowing air, with FIG. 2 showing this from the top;

FIG. 3 shows a side view of the air recovery system, and shows how the energy is used to charge a battery.

### DETAILED DESCRIPTION

The present application describes a system for charging battery packs based on fluid flow. In embodiments, the fluid can be water or air, and in other embodiments the fluid can be other different fluids.

An embodiment describes installing a DC motor to be operated by flowing water in a line, to create DC power. This DC power helps reduce the cost of power used to create the flowing to charge a battery. In an embodiment, the waterwheel is installed into an existing water line which turns the DC motor which charges the battery packs.

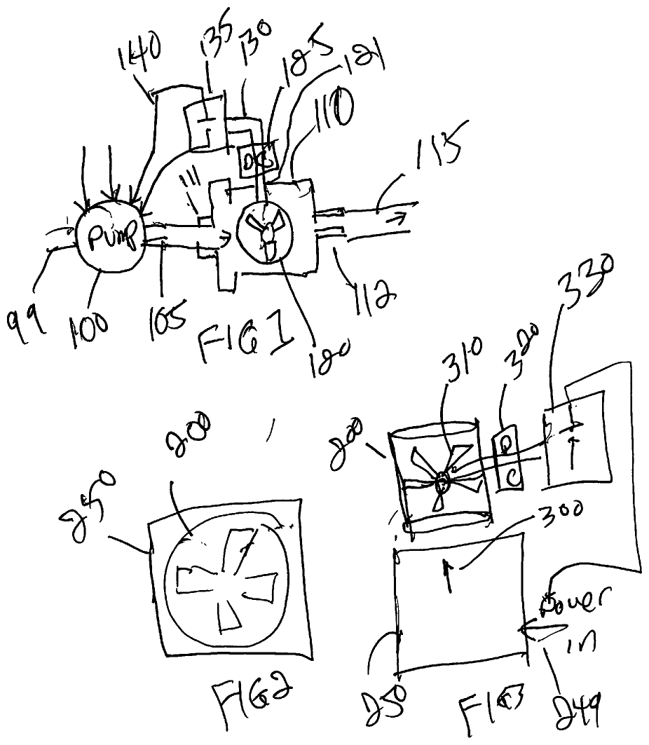

Different embodiments operate in different ways. In a first embodiment, shown in FIG. 1, a pump 100, such as as a pool motor, is driven by electric power to force water through a line 105. An adapter assembly housing 110 is attached at a first end 111 to the first end of the line 105, and has a second end 112 which connects to the water outlet 115. The adapter housing 110 includes a waterwheel 120 therein. The waterwheel in this embodiment, is propeller shaped, in a way to be driven to rotate by the flow of the water. In an embodiment, the waterwheel may take up, for example, between 10% and 60% of the volume through which the water flows.

The rotating waterwheel 120 is connected to a DC motor 125, through a waterproof rotating connection 121 through the housing 110. The rotation of the DC motor creates a DC output 130, which charges a battery 135.

If desired, an inverter can be used at this point, to change the DC power to AC power.

In the pictured embodiment, the DC power out 140 can be used to provide further drive to the pump 100. In one embodiment, the charging of the battery 135 can be used to drive the pump 100 after the pump has been deenergized from its AC source 99. For example, at the end of the day, when the pump is deenergized, the remaining power from the battery 135 can drive the pump.

As another example, if the pump is deenergized due to a power failure, the power in battery 135 can power the pump. In this way, some of the power from the running water is recycled to provide additional drive for the pump.

Another embodiment describes using this on water lines going to residential homes in order to create the DC power.

Yet another embodiment uses this on water lines to commercial and hotel buildings to create DC power. Yet another embodiment describes using this on farming and agricultural facilities to create DC power.

In an alternative embodiment, the housing is created that sits on top of an air conditioner, heat pump or cooling tower, and uses the exiting airflow to turn blades like a windmill. The blades are inside a barrel shaped device 200. FIG. 2 shows this from the top, where the air recovery device 200 sits on top of the heat pump 250.

FIG. 3 shows this from the side, where the heat pump 250 creates its airflow out the top shown as 300, which is input into the barrel shaped housing 200. The housing 200 includes a set of fan blades 310 therein. The set of fan blades rotates, to create rotation of the DC motor 320. The rotation of the DC motor, which is configured as a generator, is used to charge the battery 330. As in the other embodiments, the output from the battery can be used by itself, or through an inverter, to supplement the power input 249 to the heat pump. In this way, the heat pump can continue to operate either after it is turned off, or after power has been lost.

In one embodiment, this can be used, for example, for smart kinds of pumps. For example, in this embodiment, the water pump 100, or air pump 250 is a computer-based device, which prefers to have an ordered shutdown instead of being deenergized Accordingly, at the time of a power failure, or when power is simply turned off to the pump, the power from the battery is used to ensure that the pump carries out an orderly shutdown.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system of recycling power from flowing fluids, comprising:
a fluid pump, driven from a power source to create a flow of fluids;
a fluid movement recycling device, located in the path of the fluid flow, such that the fluid flowing causes the fluid movement recycling device to rotate;
a DC motor, receiving the rotation from the fluid movement rotating device, and producing an output of DC power; and
a battery, receiving and being charged by the DC power,
wherein an output of the battery is used to drive the fluid pump.

2. The system as in claim 1, wherein the fluid pump is a water pump.

3. The system as in claim 1, wherein the fluid pump is an air pump.

4. The system as in claim 1, wherein the fluid moving recycling device includes propellers which move based on the flow of fluid.

5. The system as in claim 2, wherein the fluid movement recycling device comprises a waterwheel, located in a chamber, and producing rotational motion which is coupled via a watertight connection to the DC motor, where the DC motor is located outside the chamber.

6. The system as in claim 5, wherein the waterwheel takes up between 10 and 60% of the volume through which the water flows.
